(19) United States
(12) Patent Application Publication
(10) Pub. No.: US 2013/0060715 A1
(43) Pub. Date: Mar. 7, 2013

(54) INTELLECTUAL PROPERTY COMMERCIALIZATION SUPPORTING SYSTEM CAPABLE OF DIVERSIFYING INVESTMENT RISK BASED ON SOCIAL NETWORK

(71) Applicants: Chang-Min Kil, Suwon-si (KR); Seung-Tae Jang, Seoul (KR)

(72) Inventors: Chang-Min Kil, Suwon-si (KR); Seung-Tae Jang, Seoul (KR)

(21) Appl. No.: 13/560,465

(22) Filed: Jul. 27, 2012

(30) Foreign Application Priority Data
Sep. 6, 2011 (KR) 10-2011-0090364

(51) Int. Cl. G06Q 40/06

(52) U.S. Cl. 705/36 R

(57) ABSTRACT

Provided is a system for supporting intellectual property (IP) commercialization based on a social network in which business experts, a technology provider, and optionally capital investors can join. The system includes a project information providing unit configured to provide investment project information over a computer network, the investment project information including technical description of a target technology to be commercialized by a technology provider; an investment processing unit configured to store, as the project information, outcomes generated from knowledge-based services which are offered by participants for individual business elements required for commercialization of the target technology; and an investment share managing unit configured to manage shares converted from knowledge-based services offered by investors for the project, on the individual project/investor basis.

### CROSS-REFERENCE TO RELATED APPLICATION(S)

This application claims the benefit under 35 U.S.C.§119(a) of Korean Patent Application No. 10-2011-0090364, filed on Sep. 6, 2011, in the Korean Intellectual Property Office, the entire disclosure of which is incorporated herein by reference for all purposes.

### BACKGROUND

1. Field

The following description relates to a computing and network technology, and more particularly, to a technology for collecting business-related data through a plurality of terminals connected to a server over a network and continuously and purposively processing the collected data.

2. Description of the Related Art

Cooperation between the technology owner and the capital holder is in the national interest since it may lead the innovation to create wealth. Such cooperation has been encouraged through the technology trade, licensing, and capital investment, but these attempts are not quite successful in reality. There may be various reasons for failures in cooperation, for example, understanding gap between the technology provider and the investor, limitation of opportunity to value goods and services as input by the technology provider and the investor, and failures in the consistent provision of elements necessary for commercialization.

Korean registered Patent No. 0458530 filed by Biz Model Line Co. discloses a system for processing small investment to cultural works of art by means of various methods including points and mobile phone bill payment in addition to cash payments. Further, Korean Patent Publication No. 2004-024587 discloses an idea for supporting development costs by establishing funds which are sold in advance to future users, and in return for the support the users owning the funds are enabled to buy the developed software at lower price. In addition, the sale of preemption rights for the software is allowed, so that investors who do not practically need the software can participate in fund raising activities and obtain investment returns.

Korean Patent Publication No. 2008-48828 filed by the applicant of the present invention discloses business support system in which technical feasibility assessment of an idea technology is performed based on prior art evaluation data and technology trend analysis data, business feasibility assessment is performed based on the technical feasibility assessment analysis data, market trend analysis data, industry attractiveness analysis data, technology commercialization capability-business model analysis data and net present value (NPV) calculation data, comprehensive assessment of commercialization feasibility is conducted based on the business feasibility assessment, and resulting commercialization strategy data is obtained. However, the aforementioned techniques do not merely focus on the above identified problems.

### SUMMARY

The following description relates to a system for supporting a technology provider and capital investors to commercialize a technology in a rational way by providing advice from various experts.

Accordingly, the experts investing their specialized knowledge and services can systemically diversify risks related to the uncertainty of the business.

In one general aspect, there is provided a system for supporting intellectual property (IP) commercialization based on a social network, the system including: a project information providing unit configured to provide investment project information over a computer network, the investment project information including technical description of a target technology to be commercialized by a technology provider; an investment processing unit configured to store, as the project information, outcomes generated from knowledge-based services which are offered by participants for individual business elements required for commercialization of the target technology; and an investment share managing unit configured to manage shares converted from knowledge-based services offered by investors for the project, on the individual project/investor basis.

The investment processing unit may be configured to set up a unit project on the individual business element basis, wherein the business elements include product development, securing of intellectual property rights, commercialization, marketing, and general consulting, and to support a social network for each unit project, in which investment of knowledge and service is introduced, and store and manage a resulting outcome.

The investment share managing unit may be configured to compute the converted shares in accordance with compensation pie and a valuation result of the knowledge-based services offered by each of the investors for the project, wherein the compensation pie is set for each of unit projects set up for the individual business elements including product development, securing of intellectual property rights, commercialization, marketing, and general consulting.

The investment share managing unit may be configured to include a current value assessment unit configured to manage a current assessed value price of the project. For example, the current value assessment unit may manage a current value of the project assessed by participating valuation experts.

The investment share managing unit may be configured to further include an investment valuation unit configured to manage an assessed value price of the knowledge-based service offered by each investor for the project, and a share managing unit configured to compute the converted shares in accordance with the current assessed value price from the current value assessment unit and the assessed value price from the investment valuation processing unit. Accordingly, it may be possible to rationally allocate the shares with respect to the knowledge or the services.

The system may further include a share trade processing unit configured to be connected to a plurality of seller clients and a plurality of buyer clients via a network and to trade the converted shares at current price; and an investment information database configured to manage the converted shares and their current prices on the individual project and an individual owner basis.

The system may further include a mileage point managing unit configured to manage mileage points obtained by quantifying rewards according to contribution of users to the social network; and a mileage point conversion processing unit configured to convert the converted shares of the individual users into mileage points and output the mileage points to the mileage point managing unit.

The system may further include a mileage point managing unit configured to manage mileage points obtained by quantifying rewards according to contribution of users to the social network; a share trade processing unit configured to be connected to a plurality of seller clients and a plurality of buyer clients via a network and trade the converted shares at current price, and to pay at least some of trade amount with the mileage points; and an investment information database configured to manage the converted shares and their current prices on the individual project and an individual owner basis.

Other features and aspects may be apparent from the following detailed description, the drawings, and the claims.

### BRIEF DESCRIPTION OF THE DRAWINGS

FIG. 1 is a diagram illustrating a system for supporting intellectual property (IP) commercialization according to an exemplary embodiment of the present invention.

FIG. 2 is a schematic block diagram of the system for supporting IP commercialization shown in FIG. 1.

FIG. 3 is a flowchart illustrating a method for supporting IP commercialization according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

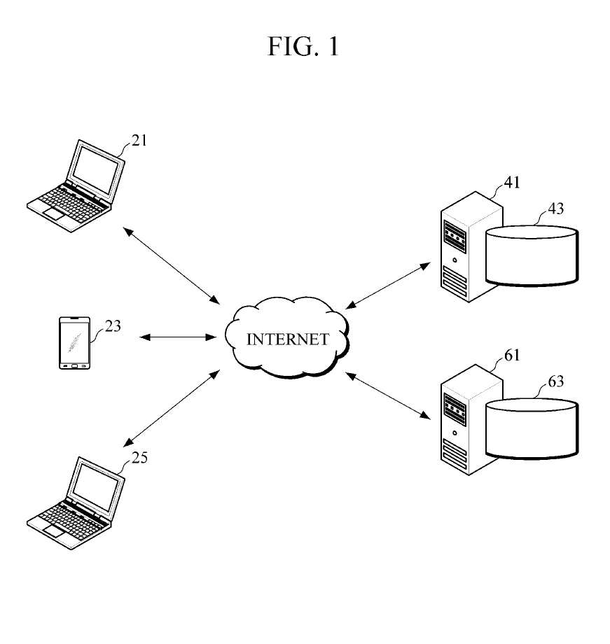

FIG. 1 is a diagram illustrating a system for supporting intellectual property (IP) commercialization according to an exemplary embodiment of the present invention. As shown in FIG. 1, the IP commercialization support system may include a service server 41 in the form of a social network, a database 43, and a plurality of terminals 21, 23, and 25 connected to the service server 41 via a wired or a wireless Internet network. The terminals 21, 23, and 25 include a variety of terminals, such as personal computers 21 and 25, and a smartphone 23, which can be provided with services by a server computer. A server system may include a plurality of physical servers 41 and 61 and a plurality of databases 43 and 63. In the example illustrated in FIG. 1, each of the server computers and the terminals is equipped with a computer program for implementing a commercialization supporting system.

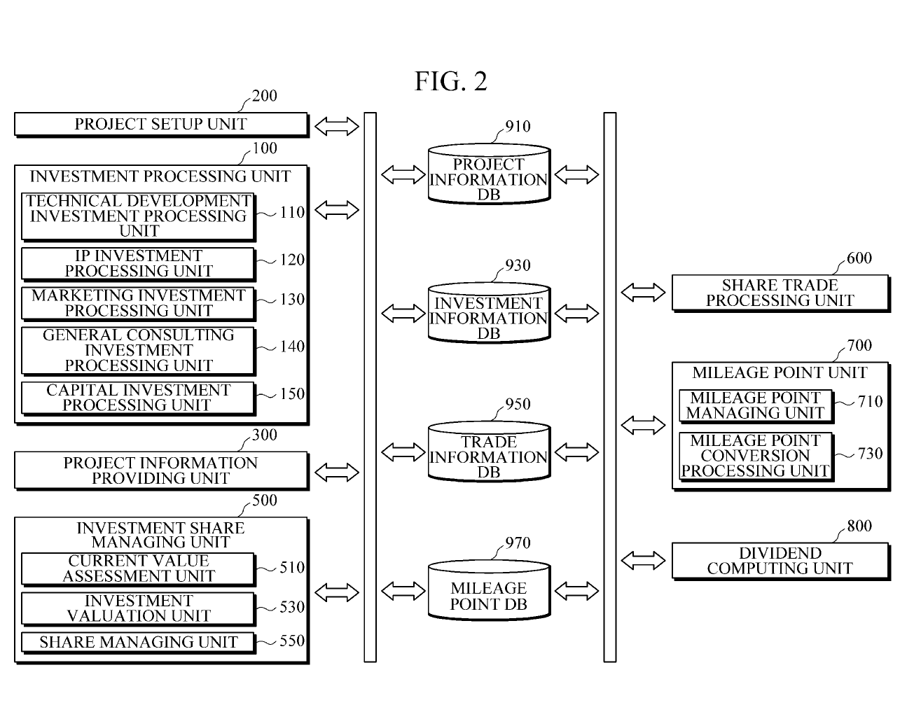

FIG. 2 is a schematic block diagram of the system for supporting IP commercialization shown in FIG. 1. The system may be based on a social network which may include business professionals, technology providers, and, optionally, capital investors. Although not illustrated, users accessing the commercialization support system via terminals participate in each project after membership verification process. Only the members of this system who have agreed on a confidentiality agreement for each project are allowed to participate in the project or to view the relevant information.

As shown in FIG. 2, the intellectual property commercialization support system may include a project information providing unit 300, an investment processing unit 100, and an investment share managing unit 500. The project information providing unit 300 provides investment project information including the description of a target technology to be commercialized, the investment processing unit 100 stores project information by accumulating results from knowledge-based services offered by the participants of each technology commercialization project, and the investment share managing unit 500 manages shares converted from the knowledge-based services offered by investors, on the individual investor/project basis.

The system may further include a project setup unit 200. The technology provider requests to set up a project by registering the description of the target technology for commercialization through the project setup unit 200. The technical description may include a concept of a product and a business model for generating revenue from the product. Website management staff may allow the opening of the project after a simple examination. The technical description may be documented and provided.

The technology to be commercialized is not limited to technologies that are protected by intangible property rights, for example, a patent. Many experts are allowed to participate in the course of the project via a social network, and offer specialized services to the project. As a result, the technology is specified, thereby leading to participation of investors holding tangible assets such as capital and facilities.

In response to a request from other elements of the system, the project information providing unit 300 may provide overviews, subdivision of each item, and concrete specification with respect to the project information stored in a project information database 910.

The investment processing unit 100 may process various business factors such as specialized knowledge, services, and capital. The above business factors are only for purpose of examples and it should be appreciated that they may vary. The investment processing unit 100 may set up a unit project on the individual business element basis, wherein the business elements include product development, securing of intellectual property rights, commercialization, marketing, and general consulting. In addition, the investment processing unit 100 may support a social network for each unit project, in which knowledge and service are invested, and store and manage a resulting outcome.

In the example shown in FIG. 2, a technical development investment processing unit 110 is implemented as an engineer social network on which technical experts from the relevant fields of the original technology to cooperate in writing the detailed technical description. The technical experts conduct discussion on the ongoing technology project and present an improvement plan. Specialized knowledge or ideas of each of technical experts are recorded and managed by their sources and references. The resultant information is stored in the project information database 910.

A marketing investment processing unit 130 is implemented as a marketing expert social network for participation of marketing experts. Participants of this social network inspect the detailed technical description, conduct market research, and establish marketing strategy. The resultant information is stored in the project information database 910.

An IP investment processing unit 120 may be implemented as an IP expert social network for participation of IP experts. The IP investment processing unit 120 may support securing property rights or assessing a value of a variety of knowledge and ideas derived from each element of the investment processing unit 100. The IP experts of one social network join a different social network in response to a request from the social network, or inspect information of the requesting social network and offer an IP-related service or knowledge. For example, the IP experts may pursue patent rights for the originally registered technical description or new ideas provided by a technical development investment processing unit 110. As another example, the IP experts may proceed with trademark application for the brands created by the marketing investment processing unit 130. The monetary value of knowledge and ideas provided by the technical development investment processing unit 110 may be assessed by technology valuation experts joining in the IP expert social network. In the course of pursuing IP rights, a number of IP experts may cooperate with each other by exchanging opinions and refining the result.

A general consulting investment processing unit 140 may be implemented as an expert social network for participation of a diversity of experts from various fields. A legal expert provides advice on various legal issues arising or predicted to arise during the process from business promotion to commercialization of the technology. Services offered by the legal experts may be assessed by the time spent by each expert. Business consulting experts provide professional advice on various business problems. Business executives as the subject of the project may assign a weight to these issues according to its urgency, thereby promoting the more active participation of the experts.

A capital investment processing unit 150 manages a social network for investment of tangible assets, such as cash, securities, real estates, and movable property, and resultant data. Convertible shares of the tangible asset investment may be determined according to a value assessment result.

The social networks of the investment processing unit 100 may be organically connected to each other when necessary. For example, in some cases an outcome of one social network may be shared with other social networks and in other cases, it may not be shared. The decision whether to share the outcome with other social network may be made by a participant that generates the information. The allowable range of information sharing may be set when the participant inputs the generated information. The information itself that is generated in one social network can be a new issue, that is, an input, on another social network. Such information is shared in the project information providing unit 300 via the project information database 910. The project information providing unit 300 classifies information on the individual project basis based on the verification of the participants, and generates contents of a display screen by combining information selected among the corresponding project information allowed to the relevant participant.

The investment share managing unit 500 manages the shares converted from the knowledge-based services offered by investors for the project, on the individual project/investor basis. In one example, the amount of shares converted from the knowledge-based services offered by the investors may be determined through discussion and examination within a corresponding social network of the individual investment processing units 110, 120, 130, 140, and 150.

In another example, the investment share managing unit 500 may set “compensation pies” on the individual unit project basis, wherein the unit project is conducted for each of business elements including product development, securing of IP rights, commercialization, marketing and general consulting. In addition, the investment share managing unit 500 may calculate the converted shares in accordance with a valuation of the knowledge-based service offered by the investor participating in a relevant project. For example, the investment share managing unit 500 may assign 200 shares to be technical development stage, 100 shares to IP-right-seeking stage, 50 shares to marketing stage, and 100 shares to general consulting stage. In another example, the compensation pie may be set in accordance with a ratio of stock shares ensured to the investors at the time of going public. In still another example, a value of the knowledge-based service offered by the investor may be determined by arrangement between other participants of the same social network or the same unit project. Each of the elements 110 to 150 in the investment processing unit 100 may provide a user interface for the arrangement and output the value derived from the arrangement to the investment share managing unit 500. The value may be produced as, for example, a monetary value or a ratio to the entire pie of the corresponding unit project. The investment share managing unit 500 calculates the converted share by multiplying the compensation pie by the determined value.

More specifically, the investment share managing unit 500 may further include a current value assessment unit 510 to manage a current assessed value price of the project. Enterprise valuation experts joining in the social network of the IP investment processing unit 120 may assess a value of the project based on various data stored in the project information database 910, including technical description, marketing strategy, and market prediction with respect to the relevant technology, and input the assessed price to the project information database 910. The current value assessment unit 510 processes diverse evaluation factors and inputs a resulting assessed price of the project.

In another example, the investment share managing unit 500 may include an investment valuation unit 530 to evaluate a value of the knowledge-based service offered by the investor for the project and a share managing unit 550 to compute the converted share in accordance with the value price of the project as assessed by the current value assessment unit 510 and the value price of the knowledge-based service as assessed by the investment valuation unit 530. In one example, the experts joining in the social networks of the investment processing unit 100 assess the offered professional knowledge or services for its monetary value. The assessments by the experts are collected to determine an assessed price of the knowledge or the service, and the assessed price is input to the investment valuation unit 530. The share managing unit 550 compares the current assessed price of the project and the assessed price of the knowledge-based service as determined by the investment valuation unit 530 to compute the converted shares to be assigned. In another example, the determination of the final converted shares may be made by the largest shareholder or arrangement between shareholders.

In one embodiment, the system may further include a dividend computing unit 800 to compute a distribution amount from a received income in accordance with the converted shares. The income may be a sales profit generated at the end of each fiscal year.

The system may include a share trade processing unit 600 and an investment information database 930. The share trade processing unit 600 is connected to a plurality of seller clients and a number of buyer clients via a network and trades the converted shares at current price. The investment information database 930 manages the converted shares and the current price of the convert shares, on the individual project basis and on the individual owner basis. The current price does not need to be the same as the current value price of the project assessed by the enterprise valuation expert, and the current price may vary according to future value and demand and supply.

The commercialization support system may further include a mileage point managing unit 710 and a mileage point conversion processing unit 730. The mileage point managing unit 710 manages mileage points obtained by quantifying rewards according to the contribution of users to the social network. The mileage point conversion processing unit 730 converts a converted share into mileage points and output the mileage points to the mileage point managing unit 710. In one embodiment, the mileage point may be given depending on how much each expert is actively involved with the commercialization support system, for example, the frequency of visit to the system, the number of professional service uploads, and the amount of access time. For example, when the pertinent project is cancelled midway, the mileage point conversion processing unit 730 may convert the converted shares allocated to the project into mileage points under the control of a system operator. As another example, the mileage point conversion processing unit 730 may convert the converted shares owned by a participant into mileage points under the control of the system operator when the participant stops involving in or withdraws from the project.

As still another example, the mileage point managing unit 710 may manage mileage points obtained by quantifying rewards according to the contribution of users to the social network, the share trade processing unit 600 may be connected to a number of seller clients and a number of buyer clients via a network and trade the converted shares at current price, and pay at least some of trade amount with the mileage points converted, and the investment information database 930 may manage the converted shares and the current price of the shares on the individual project/owner basis. In this example, the mileage points can be used as money for buying converted shares of another project.

A method for supporting IP commercialization through a variety of networks is disclosed herein, corresponding to the aforementioned various embodiments of the IP commercialization support system based on a social network. The detailed description of the equivalent method will be omitted. The method for supporting IP commercialization is implemented as a program to be executed on a server computer connected to a plurality of terminals over a network.

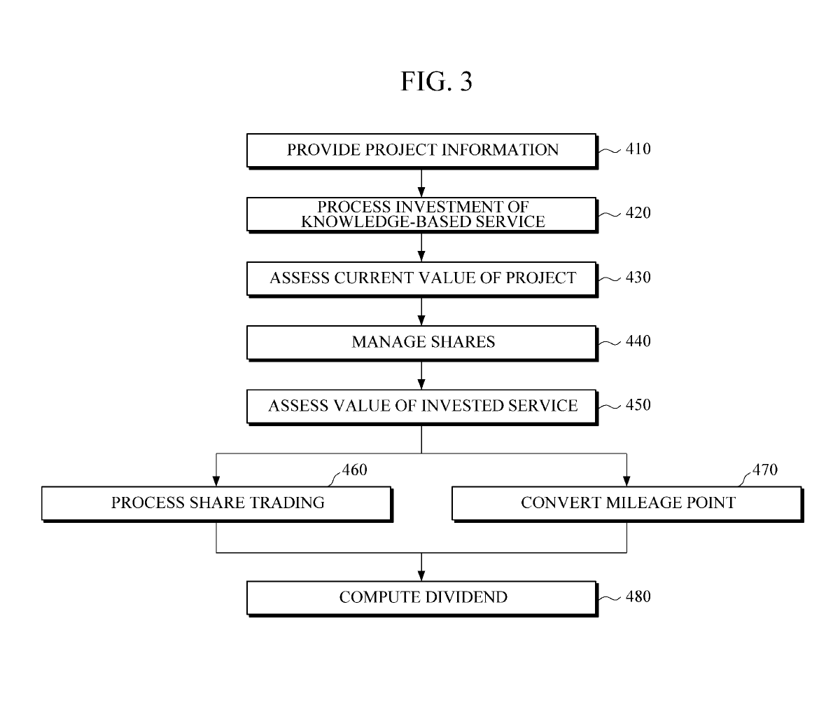

FIG. 3 is a flowchart illustrating a method for supporting IP commercialization according to an exemplary embodiment of the present invention. As shown in FIG. 3, in 410, investment project information is provided through a computer network, wherein the investment project information contains description of a target technology provided by a technology provider for commercialization. An outcome generated from a knowledge-based service offered by each of participants of individual business elements for commercialization of the target technology is stored as project information in 420. In 430 and 440, shares converted in return for the knowledge-based services offered by investors for the project are managed on the individual project/investor basis.

In one embodiment, in 430, a current value price of the project may be assessed, and in 450, a value price of the knowledge-based service offered by the investor for the project may be assessed. In 440, the converted shares are computed in accordance with the current assessed value price of the project and the assessed value price of the knowledge-based service.

In another embodiment, a unit project may be set up for each of the business elements including product development, securing of intellectual property rights, commercialization, marketing, and general consulting, and a social network may be formed for the support of each unit project, so that participants can introduce knowledge and service investment to the social network and can store and manage a resulting outcome.

In still another embodiment, the converted shares may be computed in accordance with a compensation pie and a valuation result of the knowledge-based service offered by an investor participating in the project, wherein the compensation pie is set for each of unit projects set up for the individual business elements including product development, securing of intellectual property rights, commercialization, marketing, and general consulting.

In yet still another embodiment, a plurality of seller clients and a plurality of buyer clients, may trade the converted shares at current price wherein the seller clients and the buyer clients are connected to each other via a network in 460.

In yet another embodiment, the users' converted shares may be converted into mileage points and output to the mileage point managing unit in 470.

In yet another embodiment, when a plurality of seller clients and a plurality of buyer clients are trading the converted shares at current price via a network, at least some of trade amount may be paid by the mileage points in 460.

In yet another embodiment, dividend amounts may be computed from a received income in accordance with the converted shares in 480.

According to the above described embodiments, the experts may invest knowledge-based services to the technology provider, and be allocated contribution pie in accordance with valuations of the services as invested. In addition, since the system is based on a network which enables a number of experts to join in, it is possible for the individual experts to invest their spare time for a project and thus diversify risk.

Moreover, it is possible to reasonably allocate shares in return for invested knowledge or services in consideration of both a valuation of a project and an assessment of the invested knowledge or services.

Furthermore, since the converted shares can be trade prior to commercialization of the technology, it may be advantageous to an investor in that investment period can be reduced. In addition, investors who fail in investment or stop investing for personal reasons can convert their converted shares into mileage points, and use the mileage for investing in other projects or attempt to trade the mileage points into money.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

1. A system for supporting intellectual property (IP) commercialization based on a social network, the system comprising:
a project information providing unit configured to provide investment project information over a computer network, the investment project information including technical description of a target technology to be commercialized by a technology provider;
an investment processing unit configured to store, as the project information, outcomes generated from knowledge-based services which are offered by participants for individual business elements required for commercialization of the target technology; and
an investment share managing unit configured to manage shares converted from knowledge-based services offered by investors for the project, on the individual project/investor basis.

2. The system of claim 1, wherein the investment share managing unit is configured to comprise a current value assessment unit configured to manage a current assessed value price of the project.

3. The system of claim 2, wherein the investment share managing unit is configured to further comprise
an investment valuation unit configured to manage an assessed value price of the knowledge-based service offered by each investor for the project, and
a share managing unit configured to compute the converted shares in accordance with the current assessed value price from the current value assessment unit and the assessed value price from the investment valuation processing unit.

4. The system of claim 1, wherein the investment share managing unit is configured to compute the converted shares in accordance with compensation pie and a valuation result of the knowledge-based services offered by each of the investors for the project, wherein the compensation pie is set for each of unit projects set up for the individual business elements including product development, securing of intellectual property rights, commercialization, marketing, and general consulting.

5. The system of claim 1, wherein the investment processing unit is configured to set up a unit project on the individual business element basis, wherein the business elements include product development, securing of intellectual property rights, commercialization, marketing, and general consulting, and to support a social network for each unit project, in which investment of knowledge and service is introduced, and store and manage a resulting outcome.

6. The system of claim 1, further comprising:
a share trade processing unit configured to be connected to a plurality of seller clients and a plurality of buyer clients via a network and to trade the converted shares at current price; and
an investment information database configured to manage the converted shares and their current prices on the individual project and an individual owner basis.

7. The system of claim 1, further comprising:
a mileage point managing unit configured to manage mileage points obtained by quantifying rewards according to contribution of users to the social network; and
a mileage point conversion processing unit configured to convert the converted shares of the individual users into mileage points and output the mileage points to the mileage point managing unit.

8. The system of claim 1, further comprising:
a mileage point managing unit configured to manage mileage points obtained by quantifying rewards according to contribution of users to the social network;
a share trade processing unit configured to be connected to a plurality of seller clients and a plurality of buyer clients via a network and trade the converted shares at current price, and to pay at least some of trade amount with the mileage points; and
an investment information database configured to manage the converted shares and their current prices on the individual project and an individual owner basis.

9. A method, implemented as a computer program to be executed in a server computer connected to a plurality of terminals via network, for supporting intellectual property (IP) commercialization based on a social network, the method comprising:
providing investment project information over a computer network, the investment project information including technical description of a target technology to be commercialized;
storing, as the project information, outcomes generated from knowledge-based services which are offered by participants for individual business elements required for commercialization of the target technology by a technology provider; and
managing shares converted from knowledge-based services offered by investors for the project, on the individual project/investor basis.

10. The method of claim 9, wherein the managing of the shares comprises determining a current assessed value price of the project, determining an assessed value price of the knowledge-based service offered by each investor for the project, and computing the converted shares in accordance with the current assessed value price and the assessed value price.

11. The method of claim 9, wherein the managing of the shares comprises computing the converted shares in accordance with compensation pie and a valuation result of the knowledge-based services offered by each of the investors for the project, wherein the compensation pie is set for each of unit projects set up for the individual business elements including product development, securing of intellectual property rights, commercialization, marketing, and general consulting.

12. The method of claim 9, wherein the storing of the outcome comprises setting up a unit project on the individual business element basis, wherein the business elements include product development, securing of intellectual property rights, commercialization, marketing, and general consulting, supporting a social network for each unit project, in which investment of knowledge and service is introduced, and storing and managing a resulting outcome.

13. The method of claim 9, further comprising:
trading the converted shares at current price with a plurality of seller clients and a plurality of buyer clients, which are connected via a network.

14. The method of claim 9, further comprising:
converting the converted shares of the individual users into mileage points and outputting the mileage points to a mileage point managing unit.

15. The method of claim 9, further comprising:
trading the converted shares at current price with a plurality of seller clients and a plurality of buyer clients, which are connected via a network, and paying at least some of trade amount with the mileage points.

16. A computer readable recording medium having embodied thereon a computer program for executing a method according to claim 9.

17. A computer readable recording medium having embodied thereon a computer program for executing a method according to claim 13.

18. A computer readable recording medium having embodied thereon a computer program for executing a method according to claim 14.

19. A computer readable recording medium having embodied thereon a computer program for executing a method according to claim 15.

20. A server computer having a computer program for executing a method according to claim 9.
